(19) United States
(12) Patent Application Publication
(10) Pub. No.: US 2025/0259365 A1
(43) Pub. Date: Aug. 14, 2025

(54) DEVICE, SYSTEM, AND METHOD FOR CONTROLLING DEVICE

(71) Applicant: AnotherBall Pte. Ltd., Singapore (SG)

(72) Inventor: Shoji Fukunaga, Tokyo (JP)

(73) Assignee: AnotherBall Pte. Ltd., Singapore (SG)

(21) Appl. No.: 19/051,647

(22) Filed: Feb. 12, 2025

(30) Foreign Application Priority Data
Feb. 14, 2024 (JP) 2024-020547

(51) Int. Cl. G06T 13/40; G06T 7/73; G06T 13/80

(52) U.S. Cl. CPC G06T 13/40; G06T 7/73; G06T 13/80; G06T 2207/30201

(57) ABSTRACT

A computer is caused to execute a generation step of generating a plurality of derived images in which a character is drawn at mutually different angles or postures on a basis of an input image including the character, and a registration step of registering the derived image as a distribution image for causing the character to move.

### BACKGROUND OF THE INVENTION

### 1. Technical Field

The present invention relates to a character image generation technique.

### 2. Description of the Related Art

JP 2021-111102 A discloses that derived images in a state where eyes and a mouth are opened and closed are generated for an input character image, and a moving image in which an expression changes is generated by using the derived images.

JP 2021-071843 A discloses that a feature amount of a skeleton of a character in an input image is extracted, a similar image having a feature amount similar to the extracted feature amount is extracted from a database (DB), and an image in a case where the skeleton is applied to the character in the input image is generated on the basis of a value related to an angle of a skeleton of a character drawn in the similar image.

### SUMMARY OF THE INVENTION

In the technique disclosed in JP 2021-111102 A, the application target is only a face, and for example, the application is limited in a case of an avatar that performs a motion of turning around.

In the technique disclosed in JP 2021-071843 A, an image in which a body part corresponding to a posture desired to be taken is drawn is required for a character of an input image, and such an image needs to be accumulated in a DB.

In view of such a conventional technique, the present invention provides a technique of generating a distribution image for causing a character to move in a more varied manner.

One aspect of the present invention is to cause a computer to execute: a generation step of generating a plurality of derived part images in which a character is drawn at mutually different angles or postures on a basis of an input image including the character; and a registration step of registering the derived part image as a distribution image for causing the character to move, and managing the plurality of derived part images in association with a parameter used for generating the plurality of derived part images.

According to the configuration of the present invention, a technique of generating a distribution image for causing a character to move in a more varied manner can be provided.

### BRIEF DESCRIPTION OF THE DRAWINGS

FIG. 1 is a block diagram illustrating a configuration example of a system;

FIG. 2 is a flowchart of processing performed by a system for a viewer to view a content distributed by a distributor;

FIG. 3 is a flowchart of processing performed by the system to generate avatar data corresponding to a character from an image including the character (character image);

FIG. 4 is a diagram illustrating an example of derived images of respective expressions of a character;

FIG. 5 is a diagram illustrating an example of parts of a face of a character;

FIG. 6 is a diagram illustrating an example of a character image (input image) of a character; and

FIGS. 7A to 7D are diagrams illustrating examples of a plurality of derived images in which a character is drawn at mutually different angles or postures.

### DETAILED DESCRIPTION

Hereinafter, embodiments will be described in detail with reference to the accompanying drawings. Note that the following embodiments do not limit the invention according to the claims, and all combinations of features described in the embodiments are not necessarily essential to the invention. Two or more features of a plurality of features described in the embodiments may be freely combined. Furthermore, the same or similar configurations are denoted by the same reference signs, and redundant description will be omitted.

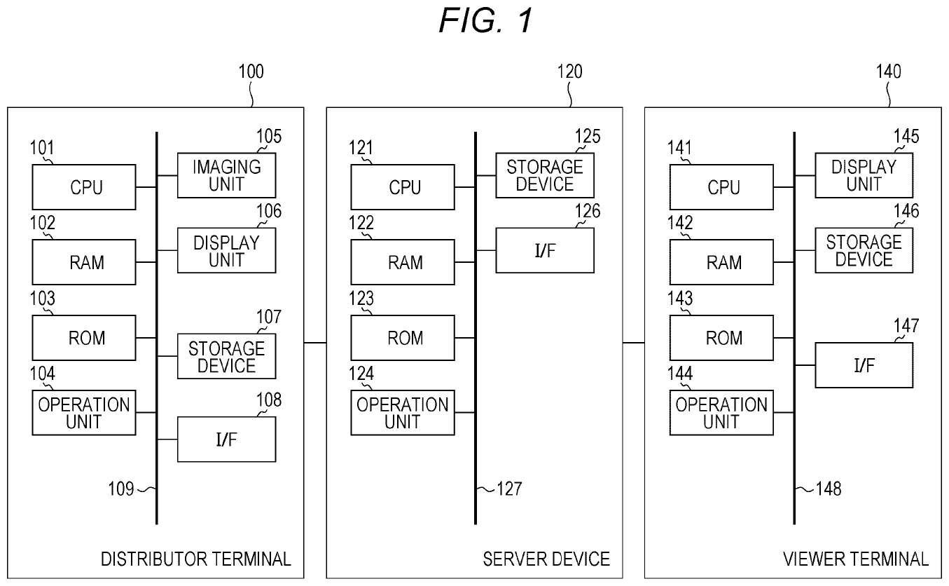

First, a configuration example of a system according to an embodiment of the present invention will be described with reference to a block diagram of FIG. 1. As illustrated in FIG. 1, the system includes a distributor terminal 100, a server device 120, and a viewer terminal 140, and each device is connected to a network such as the Internet. Note that, in FIG. 1, the number of devices of each of the distributor terminal 100, the server device 120, and the viewer terminal 140 is one in order to simplify the description, but the number may be two or more.

First, the distributor terminal 100 will be described. The distributor terminal 100 is a terminal device operated by a distributor such as a Vtuber, and is a computer device such as a personal computer (PC), a tablet terminal device, or a smartphone.

A central processing unit (CPU) 101 executes various types of processing using a computer program and data stored in a random-access memory (RAM) 102. As a result, the CPU 101 controls operation of the entire distributor terminal 100 and executes various types of processing described as processing performed by the distributor terminal 100.

The RAM 102 appropriately provides various areas including an area for storing a computer program and data loaded from a ROM 103 and a storage device 107, an area for storing a computer program and data received from the outside via an interface (I/F) 108, a work area used in a case where the CPU 101 executes various types of processing, and the like.

The ROM 103 stores setting data of the distributor terminal 100, a computer program and data related to activation of the distributor terminal 100, a computer program and data related to basic operation of the distributor terminal 100, and the like.

An operation unit 104 is a user interface such as a keyboard, a mouse, and a touch panel screen, and can input various instructions and information to the distributor terminal 100 by being operated by a distributor.

An imaging unit 105 captures a moving image and outputs an image of each frame in the moving image. Note that, in FIG. 1, the imaging unit 105 is built in the distributor terminal 100, but may be externally attached to the distributor terminal 100.

A display unit 106 includes a liquid crystal screen or a touch panel screen, and displays a processing result by the CPU 101 using an image, a character, or the like.

The storage device 107 is a large-capacity information storage device such as a hard disk drive. The storage device 107 stores a computer program, data, and the like for causing the CPU 101 to execute various types of processing described as processing performed by the OS and the distributor terminal 100.

The I/F 108 is a communication interface for performing data communication with an external device via a network such as the Internet.

The CPU 101, the RAM 102, the ROM 103, the operation unit 104, the imaging unit 105, the display unit 106, the storage device 107, and the I/F 108 are all connected to a system bus 109.

Next, the server device 120 will be described. The server device 120 is a computer device such as a PC, a tablet terminal device, or a smartphone.

A CPU 121 executes various types of processing using a computer program and data stored in a RAM 122. As a result, the CPU 121 controls operation of the entire server device 120 and executes various types of processing described as processing performed by the server device 120.

The RAM 122 appropriately provides various areas including an area for storing a computer program and data loaded from a ROM 123 and a storage device 125, an area for storing a computer program and data received from the outside via an I/F 126, a work area used in a case where the CPU 121 executes various types of processing, and the like.

The ROM 123 stores setting data of the server device 120, a computer program and data related to activation of the server device 120, a computer program and data related to basic operation of the server device 120, and the like.

An operation unit 124 is a user interface such as a keyboard, a mouse, and a touch panel screen, and can input various instructions and information to the server device 120 by being operated by a user of the server device 120.

The storage device 125 is a large-capacity information storage device such as a hard disk drive. The storage device 125 stores a computer program, data, and the like for causing the CPU 121 to execute various types of processing described as processing performed by the OS and the server device 120.

The I/F 126 is a communication interface for performing data communication with an external device via a network such as the Internet.

The CPU 121, the RAM 122, the ROM 123, the operation unit 124, the storage device 125, and the I/F 126 are all connected to a system bus 127.

Next, the viewer terminal 140 will be described. The viewer terminal 140 is a terminal device operated by a viewer who views a distribution content by a distributor, and is a computer device such as a PC, a tablet terminal device, or a smartphone.

A CPU 141 executes various types of processing using a computer program and data stored in a RAM 142. As a result, the CPU 141 controls operation of the entire viewer terminal 140 and executes various types of processing described as processing performed by the viewer terminal 140.

The RAM 142 appropriately provides various areas including an area for storing a computer program and data loaded from a ROM 143 and a storage device 146, an area for storing a computer program and data received from the outside via an I/F 147, a work area used in a case where the CPU 141 executes various types of processing, and the like.

The ROM 143 stores setting data of the viewer terminal 140, a computer program and data related to activation of the viewer terminal 140, a computer program and data related to basic operation of the viewer terminal 140, and the like.

An operation unit 144 is a user interface such as a keyboard, a mouse, and a touch panel screen, and can input various instructions and information to the viewer terminal 140 by being operated by a viewer.

A display unit 145 includes a liquid crystal screen or a touch panel screen, and displays a processing result by the CPU 141 using an image, a character, or the like.

The storage device 146 is a large-capacity information storage device such as a hard disk drive. The storage device 146 stores a computer program, data, and the like for causing the CPU 141 to execute various types of processing described as processing performed by the OS and the viewer terminal 140.

The I/F 147 is a communication interface for performing data communication with an external device via a network such as the Internet.

The CPU 141, the RAM 142, the ROM 143, the operation unit 144, the display unit 145, the storage device 146, and the I/F 147 are all connected to a system bus 148.

Note that the hardware configuration of each device illustrated in FIG. 1 is an example, and the present invention is not limited to the configuration illustrated in FIG. 1.

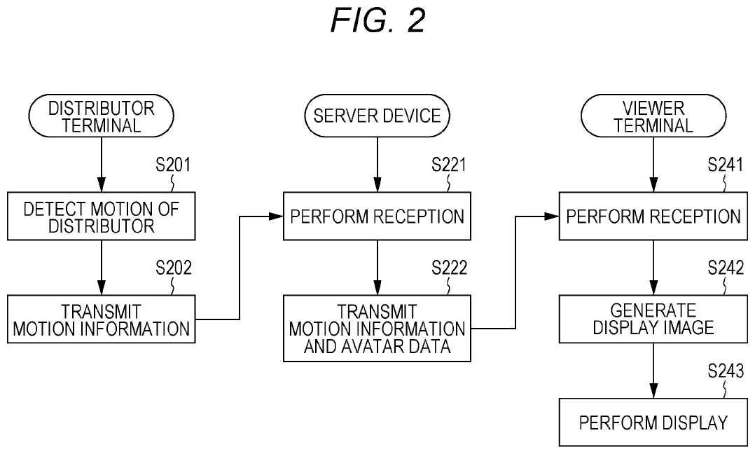

Next, processing performed by the system for a viewer to view a content distributed by a distributor will be described with reference to the flowchart of FIG. 2.

In step S201, the distributor terminal 100 detects a motion and state of the distributor. Hereinafter, an example of processing in step S201 will be described. The imaging unit 105 captures a moving image of the distributor, and an image of each frame in the moving image is stored in the RAM 102. The CPU 101 detects a motion and state of the distributor on the basis of the image of each frame of the distributor stored in the RAM 102. A technique for detecting a motion of a distributor from an image of the distributor is, for example, a well-known image recognition technique using a machine learning model learned to output the position, posture, open/close state, and shape of a face or a part of a body of a person or a portion such as an eye or a mouth in an input image. The motion and state to be detected may be, for example, a feature amount of a skeleton of a distributor in an image or displacement information of the feature amount in time series, or may be positions, postures, and states such as open/close states of portions of the distributor (head, arm, foot, upper body, lower body, and the like) and portions included in the face (eyes, nose, mouth, ears, contours, head hair, beard, eyelashes, eyebrows, decorative products, and the like) or displacement information thereof in time series. Such detection processing is executed using a conventional face recognition technique.

In step S202, the distributor terminal 100 transmits motion information indicating the motion and the state detected in step S201 to the server device 120 via the I/F 108.

In step S221, the server device 120 receives the motion information transmitted from the distributor terminal 100 via the I/F 126.

In step S222, the server device 120 transmits (distributes) the motion information received in step S221 and avatar data generated by processing to be described below to the viewer terminal 140 via the I/F 126. Specifically, the motion information is numerical data indicating the positions, motions (change amounts), orientations, and the like of the respective feature points of the four limbs, the torso, the head, and the eyes, the mouth, and the like included in the face of the distributor or the bones, and is motion information with which an open/close state of the eyes, the mouth, and the like included in the face can be identified. The avatar data is a set of a plurality of images for drawing a two-dimensional character (avatar) displayed and moved in accordance with the motion and state of the distributor on the viewer terminal 140. Furthermore, the avatar data is managed so as to associate the plurality of images with one character in order to form the one character. In a case where the avatar data is transmitted to the viewer terminal 140, all the avatar data may be transmitted to the viewer terminal 140 in a period before or after the viewer terminal 140 starts viewing distribution provided by the distributor, or may be transmitted every time the motion information of the distributor is transmitted.

In step S241, the viewer terminal 140 receives the motion information and the avatar data transmitted from the server device 120 via the I/F 147.

In step S242, on the basis of the motion information and the avatar data received in step S241, the viewer terminal 140 generates, as a display image, an image including a character having a motion and a state similar to the motion and the state of the distributor indicated by the motion information. Specifically, the orientation and angle of each portion such as the face and the state of each part (for example, open/close state or the like) are determined on the basis of the motion information of the distributor, an appropriate derived image included in the avatar data is selected on the basis of the determination result, and a display image is selected. For example, in a case where it is determined that the inclination of the face is 15 degrees in the left direction, the eyes are opened, and the mouth is closed on the basis of the motion information of the distributor, a derived image in which the inclination of the face is 15 degrees in the left direction, the eyes are opened, and the mouth is closed is selected, and a display image is generated on the basis of the derived image. Similarly, in a case where a portion or part other than the face is included, the state of each portion or part is determined from the motion information of the distributor, and a derived image corresponding to the determined state of each portion or part is extracted, whereby a display image of a character suitable for the motion of the distributor can be generated.

Furthermore, a specific emotion may be estimated on the basis of the opening degree of the eyes, the opening degree of the mouth, the change in the contour, and the like, and a derived image to which a corresponding emotion tag is added may be acquired on the basis of the estimated emotion. For example, for the estimation of the emotion, a learned model or the like trained to output the type of a human emotion using a human expression or a change in the human expression such as the opening degree of the eyes, the opening degree of the mouth, and the change in the contour prepared in the server device 120 in advance as inputs is used. In a case where each part of the face of the distributor satisfies a predetermined condition, the server device 120 may estimate that the distributor indicates a specific emotion or an expression for expressing the specific emotion, and may acquire a plurality of derived part images to which a tag of the estimated emotion is added.

In step S243, the viewer terminal 140 causes the display unit 145 to display the display image generated in step S242.

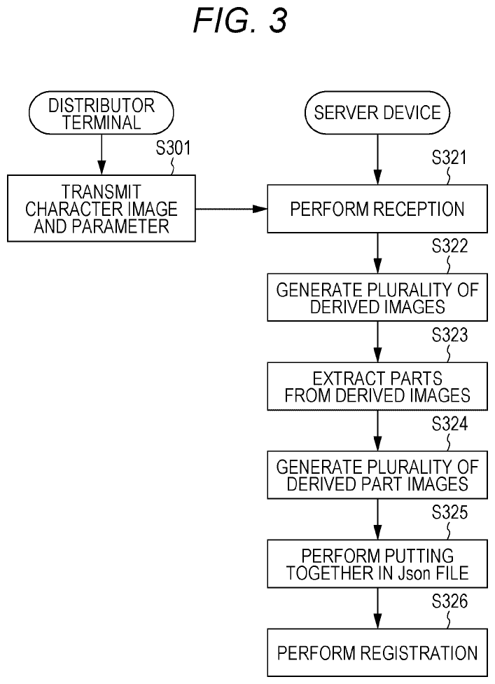

Next, processing performed by the system to generate avatar data corresponding to a character from an image including the character (character image) will be described with reference to the flowchart of FIG. 3. Note that generation of the avatar data is performed in advance in accordance with an operation of the distributor before the distributor performs distribution, and the generated avatar data is stored on the server device 120 or the distributor terminal, whereby the above-described distribution processing can be implemented.

In step S301, the distributor terminal 100 transmits a character image to the server device 120 via the I/F 108.

The character image may be an image including from the top of the head to the toe of the character, an image including a part or the whole of the upper body of the character, or an image including the upper body but not including the lower body of the character. The character image may be a character image selected by the distributor operating the operation unit 104 of the distributor terminal 100, may be a character image generated by the distributor terminal 100, or may be a preset character image.

Furthermore, the distributor terminal 100 may transmit a parameter that is a generation condition of a derived image to the server device 120, and the parameter designates, for example, a condition related to avatar data generated on the basis of a character image input by the distributor operating the operation unit 104 of the distributor terminal 100.

In step S321, the server device 120 receives the character image and the parameter transmitted from the distributor terminal 100 via the I/F 126. Note that the character image may be designated on the server device 120 side.

In step S322, the server device 120 generates a plurality of derived images in which a character is drawn at mutually different angles or postures from the character image received in step S321 on the basis of the parameter received in step S321.

In the present embodiment, the server device 120 inputs the character image received in step S321 as an input image to an image generation model learned to output at least a derived image (for example, model such as the well-known Stable Diffusion), and the image generation model performs processing to generate a plurality of derived images in which a character is drawn at mutually different angles or postures. Specifically, the server device 120 generates a prompt for instructing the image generation model to generate derived images on the basis of the image received in step S321 and the parameter received from the distributor or a parameter related to derived image generation set in the server in advance, and inputs the generated prompt to the image generation model to generate the derived images.

In step S323, the server device 120 extracts parts of the character from each of the derived images generated in step S322. For example, the server device 120 recognizes parts of the face of the character from the derived images and extracts the parts using a known technique such as Anime Face Detector or Segment Anything. Note that the server device 120 may delete unintended pixels generated at the time of segmentation (work step of separating parts from the derived images).

The processing in steps S322 and S323 will be described in more detail with a specific example.

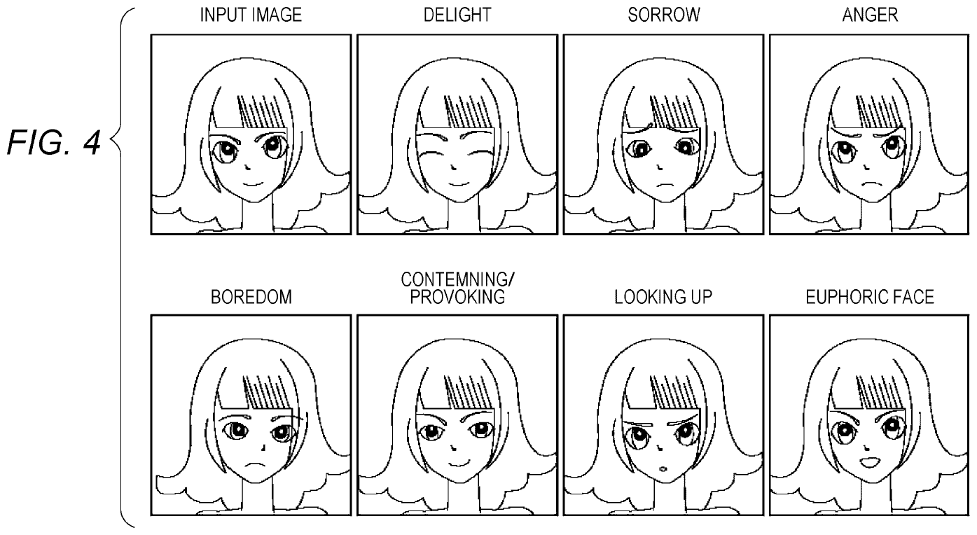

In step S322, for example, in a case where a plurality of types of expressions including “flirting, sorrow, anger, boredom, contemning/provoking, looking up, euphoric face” and the like is set as the parameter, the server device 120 generates derived images of the respective expressions of the character from the character image (input image) as illustrated in FIG. 4. Note that the types of expressions are not limited to those described herein.

Furthermore, for example, the parameter may include an instruction related to the angle at which the character is drawn in the generated derived images. As an example, the parameter may be to designate the vertical or horizontal inclination with reference to the front view of the face of the character (direction in which the face faces straight forward). Specifically, a parameter for designating an angle every 10 degrees within an angle range from an angle in which the face of the character faces left 45 degrees to an angle in which the face of the character faces right 45 degrees with respect to the front view of the face is set, and the server device 120 generates derived images of the face in which the angle changes every 10 degrees within the angle range from the character image (input image), for example, using the head vertical direction of the character as the rotation center axis (axis in the direction penetrating the head downward from the vertex of the head) on the basis of the parameter. Note that the numerical values mentioned here are merely examples, and are not limited to these numerical values.

Similarly, in a case where “angles every five degrees within an angle range from an angle in which the face of the character faces up 20 degrees to an angle in which the face of the character faces down 20 degrees” is set as the parameter, the server device 120 generates derived images of the face in a case where the angle of the face of the character changes every five degrees in the front-back direction within the angle range, for example, using the base of the neck or the base of the head of the character as a rotation center and using the rotation center as a reference from the character image (input image). Note that the numerical values mentioned here are merely examples, and are not limited to these numerical values.

Furthermore, the parameter may designate an angle in an oblique direction such that the face of the character faces diagonally upward to the right or diagonally downward to the left, such as an angle of upward 15 degrees and leftward 20 degrees or an angle of downward 15 degrees and rightward 20 degrees, in addition to upward, downward, leftward, and rightward directions.

Furthermore, the server device 120 may generate derived images in a case where the head of the character moves in the front-back and left-right inclination directions (derived images including the face in a state of facing left and right and up and down, looking down, looking up, tilting the neck to the left and right, and the like).

In this manner, the server device 120 generates derived images of a part in a case where the head moves in a 0 (rotation) direction and the front-back and left-right inclination directions (in the case of the face, the face in a state of facing left and right and up and down, looking down, looking up, tilting the neck to the left and right, and the like) using the head vertical of the character as the central axis.

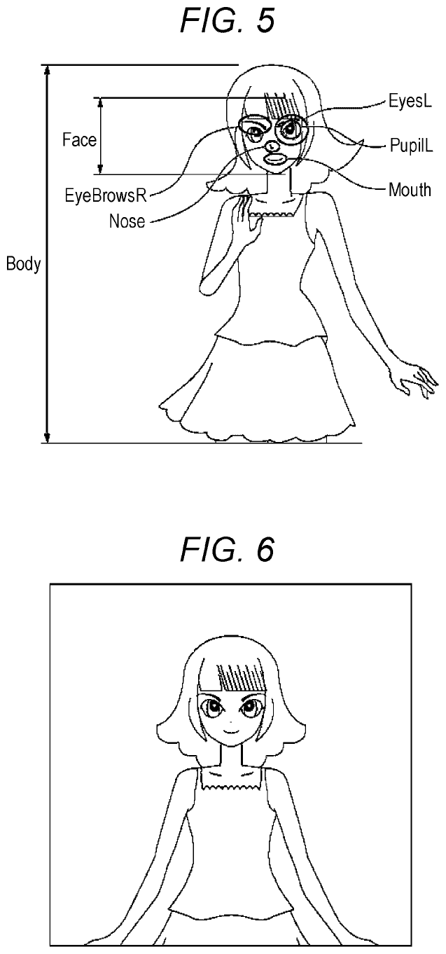

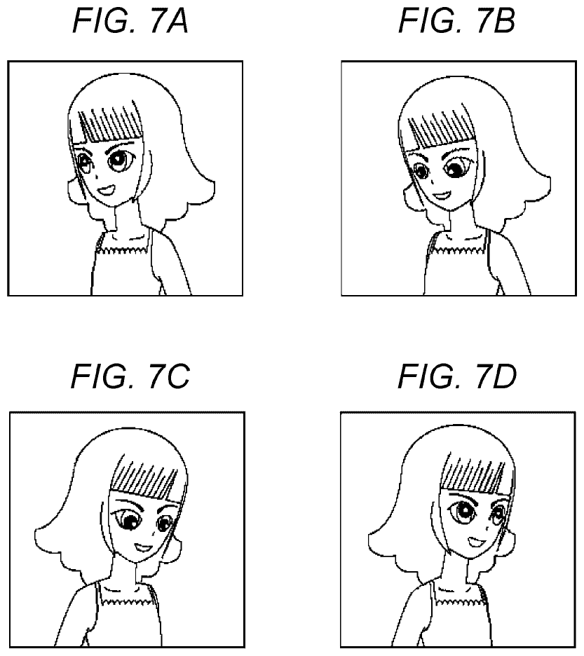

For example, in a case where a character image (input image) of a character illustrated in FIG. 6 and “range of 45 degrees in the left direction to 45 degrees in the right direction and a range of five degrees upward to 20 degrees downward using a state in which the face of the character faces the front as a reference” as a parameter are designated as the angle range, as illustrated in FIGS. 7A to 7D, the server device 120 can generate a plurality of derived images of images of a state where the character (FIG. 7A) faces in the left direction, (FIG. 7B) faces in the left diagonally downward direction, (FIG. 7C) faces in the right diagonally downward direction, and (FIG. 7D) faces in the right direction in which the character is drawn at mutually different angles or postures according to the designation of the parameter. The images drawn in FIGS. 7A to 7D are merely examples, and the present invention is not limited thereto.

Note that the server device 120 may make the number of derived images in a range in which the face of the character is visible larger than the number of derived images in a range in which the face of the character is not visible. The image in the range where the face is not visible refers to, for example, an image that does not include a part such as eyes and mouth that forms a facial expression or an image that does not include the contour of the face. Furthermore, the posture of the character in a derived image is different from the posture of the character in a character image, and the angle of the character in the derived image is different from the angle of the character in the character image.

Then, the server device 120 recognizes parts of the face of the character from each of the derived images generated in this manner and extracts the parts. For example, as illustrated in FIG. 5, “Body (head, torso, lower body)”, “Face”, “EyebrowsL (left eyebrow)”, “EyebrowsR (right eyebrow)”, “EyesL (left eye contour, white of the left eye, left eyelash)”, “PupilL (left pupil)”, “EyesR (right eye contour, white of the right eye, right eyelash)”, “PupilR (right pupil)”, “Nose”, and “Mouth” of the character included in the character image are extracted. Note that the server device 120 hierarchically manages the extracted parts in association with the original derived image and the parts extracted therefrom as follows.

### Root—Root

(a) Body
(b) Face
(c) EyebrowsL
(d) EyebrowsR
(e) EyesL
(f) PupilL
(g) EyesR
(h) PupilR
(i) Nose
(j) Mouth

In such a hierarchical structure, the parent part (parent node) of (b) is (a), and the parent part (parent node) of (c) to (j) is (b).

In step S324, the server device 120 generates a plurality of derived part images of the parts on the basis of the parts extracted in step S323 using a known image generation model such as Stable Diffusion. In this case, similarly to the derived images, the server device 120 inputs a prompt including images of the extracted parts to the image generation model as an input, and acquires derived part images generated by the image generation model. For example, the server device 120 may generate derived part images of an eyebrow in a plurality of states between the open state and the close state, may generate derived part images of an eyes at the angle of every five degrees within an angle range of the left 45 degrees to the right 45 degrees, may generate derived part images of an eye at the angle of every five degrees within an angle range of the upper 20 degrees to the lower 20 degrees, or may generate derived part images of an eye at the angle of every five degrees within an angle range of the upper 15 degrees and the left 20 degrees to the lower 15 degrees and the right 20 degrees.

Furthermore, in a case where the generated derived part images are managed in the hierarchical structure as described above, the derived part images are managed in association with information of a parameter such as the angle, the posture, and the type of expression input at the time of generation. By each of the derived part images being managed in this manner, for example, in a case where an image corresponding to the motion of the distributor is selected in the viewer terminal, an appropriate derived part image can be selected by inquiring angle information of the distributor and angle information of the generated derived part images.

Furthermore, the server device 120 may generate derived part images of hair so as to maintain feature information of a character in a derived image, for example, the line and contour of the hair and/or the contour and shape of the face of the character.

Furthermore, also for the derived part images, the server device 120 may generate derived part images not related to the face by the number smaller than the number of derived part images related to the face of the character, similarly to the derived images. As a result, even in a case where the upper limit of the number of images that can be generated is determined in advance, the degree of satisfaction of the distributor or the viewer can be maintained and improved by generating a large number of images related to the face that is likely to be affected by the avatar or the quality of distribution.

Furthermore, the server device 120 generates derived part images in a case where the character expresses delight, anger, sorrow, or pleasure, or a unique character property (personality: yandere, tsundere, little sister type, or the like) for the eyes and mouth of the character. The server device 120 may acquire/estimate such a character property by searching the WEB, and may generate, for example, derived part images related to derived emotions that are emotions obtained by further subdividing delight, anger, sorrow, or pleasure on the basis of the character property. (Basic emotion: sorrow→derived emotions: scornful eyes and tearful eyes. Furthermore, an emotion or the like such as a smile, a burst of laughter, and irritation.) Note that the derived part images generated on the basis of the character property are determined on the basis of a rule for each character property, and the server device 120 may generate the derived part images on the basis of such a rule.

Note that the server device 120 may generate derived images in a case where the character expresses delight, anger, sorrow, or pleasure, or a unique character property (personality: yandere, tsundere, little sister type, or the like).

Furthermore, the server device 120 may always generate a derived part image related to delight, anger, sorrow, or pleasure, and may generate a derived part image related to a specific character property for a character property designated by a parameter, or may generate derived part images for all preset character properties.

The derived image and/or the derived part image expressing a character property are managed by adding a tag indicating which character property the image relates to each image, and the server device 120 may set a derived image and/or a derived part image according to a selected character property as avatar data by the distributor setting a specific character property before distribution for the derived image and/or the derived part image expressing each character property. Furthermore, for the derived image and the derived part image, if motion information of the distributor satisfies a predetermined condition (that opening degree of mouth is 70% or more, that a relative position between the face and the hand is within a predetermined distance, and the like) set in advance, a derived image and/or a derived part image having a predetermined character property may be selected and displayed on the viewer screen.

Furthermore, the server device 120 may generate a derived part image so as to maintain the painting style of the derived image. The painting style indicates, for example, a feature of a character image commonly seen in an animation of a specific drawing company, a feature commonly seen in a character image drawn by a specific illustrator, and the like.

Furthermore, the server device 120 may increase or decrease the number of derived part images related to a predetermined expression or a predetermined angle as compared with other expressions or angles, or may generate a derived part image by adding a change to a predetermined part (for example, the teeth may be jagged, the color of the hair may be different, or the like). Such processing content is defined by a parameter.

Note that some of the various methods for generating derived part images described above may be charged.

Then, the server device 120, for each extracted part, generates and manages a set of {a plurality of derived part images of the part, information identifying a parent part of the part, a relative position of the part with respect to the parent part, and a reproduction speed of the plurality of derived part images} as metadata.

In step S325, the server device 120 generates a Json file including the derived images generated in step S322, the derived part images generated in step S324, and the metadata. The Json file may include the above feature information.

In step S326, the server device 120 stores (registers) the Json file generated in step S325 in the storage device 125 as avatar data. As a result, the server device 120 can register the derived images as distribution images for causing the character to move.

Thereafter, in a case where a request for transmission of avatar data of a predetermined character is received from the viewer terminal 140 via the I/F 126, the server device 120 reads the avatar data of the predetermined character from the storage device 125, and transmits the read avatar data to the viewer terminal 140 via the I/F 126. The avatar data may be transmitted as a binary file.

Then, in step S242 described above, the viewer terminal 140 generates an image of the character corresponding to the motion of the distributor as a display image on the basis of the avatar data and the motion information using a known technique such as TalkingHead. Since the avatar data includes derived images in which the character is drawn at mutually different angles or postures, the server device 120 generates the display image using the derived images and the derived part images according to the motion and state indicated by the motion information. At that time, the server device 120 may generate a character by referring to the metadata and arranging a derived part image on a derived image. For example, in a case where a derived part image of the left eye is arranged on a derived image, the server device 120 refers to the metadata and arranges the derived part image of the left eye at a relative position of the left eye with respect to the parent part “face” of the left eye. Then, the server device 120 refers to the metadata and reproduces the derived part image of the left eye at a reproduction speed of the derived part image of the left eye.

As a result, for example, the display unit 145 can be caused to display a display image in which blinking eyes and mouth flapping are implemented on the front face, and an expression of the character can be expressed using more various expressions and gestures than the expressions of the distributor.

Note that, as the display image to be displayed on the display unit 145, the original character image may be displayed in the default state.

Furthermore, in a case where an instruction to correct or regenerate a derived image or a derived part image is received from an external device such as the viewer terminal 140 or the distributor terminal 100, the server device 120 may correct or regenerate the derived image or the derived part image.

For example, upon receiving an instruction to adjust a parameter (dimension, angle, position, or the like) of a derived part image from an external device, the server device 120 regenerates the derived part image on the basis of the parameter, and updates the metadata accordingly. For example, the position of the face with respect to the body of the character is adjusted, and the angles and dimensions of parts included in the face are adjusted according to the face.

Furthermore, the distribution image may be used by the distributor for distribution, or may be an image displayed in a case where a viewer makes a comment.

Numerical values, processing timings, processing orders, processing subjects, data (information) acquisition methods/transmission destinations/transmission sources/storage locations, and the like used in the above embodiments are given as examples for specific description, and are not intended to be limited to such examples.

Furthermore, some or all of the embodiments described above may be appropriately combined and used. Furthermore, some or all of the embodiments described above may be selectively used.

The invention is not limited to the above embodiments, and various modifications and changes can be made within the scope of the gist of the invention.

What is claimed is:

1. A device comprising at least one processing unit to perform:
generation step of generating a plurality of derived part images in which a character is drawn at mutually different angles or postures on a basis of an input image including the character; and
a registration step of registering the derived part image as a distribution image for causing the character to move, and managing the plurality of derived part images in association with a parameter used for generating the plurality of derived part images.

2. The device according to claim 1, wherein in the generation step, a derived image in which a character is drawn at mutually different angles or postures is generated on a basis of an input image including the character, and a plurality of derived part images of a part of the character in the derived image is generated on a basis of the part.

3. The device according to claim 1, wherein the at least one processing unit further causes the computer to execute a step of designating the mutually different angles or postures.

4. The device according to claim 2, wherein in the generation step, the derived image is generated from the image using an image generation model learned to output at least a derived image.

5. The device according to claim 4, wherein the at least one processing unit causes the computer to execute an acceptance step of accepting the parameter that is an input condition input by a user as a generation condition of the derived image, and
in the generation step, the derived image is generated from the image using the image generation model according to the input condition.

6. The device according to claim 2, wherein in the generation step, a derived image for each expression of the character is generated.

7. The device according to claim 2, wherein a number of derived images in a range in which a face of the character is visible is larger than a number of derived images in a range in which a face of the character is not visible.

8. The device according to claim 2, wherein the parameter includes an instruction related to a range of an angle in which a character in a generated derived image is drawn.

9. The device according to claim 2, wherein in the generation step, at least one of the derived image or the derived part image is generated on a basis of information related to personality of the character acquired by the computer.

10. The device according to claim 2, wherein a number of derived part images generated from a derived image in which the character faces forward is larger than a number of derived part images generated from a derived image in which the character faces straight backward.

11. The device according to claim 2, wherein in the registration step, the derived image, the plurality of derived part images, and information indicating positions of the plurality of derived part images in the derived image are registered.

12. The device according to claim 2, wherein in the registration step, the derived image and the part are hierarchically managed in association with each other.

13. The device according to claim 2, wherein the part includes an eye, a mouth, and an eyebrow of the character.

14. The device according to claim 1, wherein the angle is an angle of a face of the character.

15. The device according to claim 1, wherein the angle is an angle within an angle range in a case where a face of the character faces left, right, up, and down.

16. The device according to claim 2, wherein a posture of the character in the derived image is different from a posture of the character in the image, and an angle of the character in the derived image is different from an angle of the character in the image.

17. The device according to claim 1, wherein in the registration step, feature information of the character in the image is registered.

18. The device according to claim 17, wherein the feature information includes a line of hair and/or a contour of a face of the character.

19. The device according to claim 1, wherein the image is an image including a part or all of an upper body of the character.

20. The device according to claim 2, wherein the device causes the computer to execute a distribution step of distributing the derived image, the plurality of derived part images, and motion information indicating a motion of a distributor.

21. The device according to claim 2, wherein in the registration step, for each of the part, some or all of a plurality of derived part images of the part, information identifying a parent part of the part, a relative position of the part with respect to the parent part, and a reproduction speed of the plurality of derived part images are generated and managed as metadata.

22. The device according to claim 1, wherein in the generation step, a part of the character is extracted from a derived image in which the character is drawn at mutually different angles or postures, and a plurality of derived part images of the part is generated on a basis of the extracted part.

23. A system comprising a distributor terminal, a server device, and a viewer terminal, wherein
the distributor terminal includes:
an acquisition unit that acquires motion information indicating a motion of a distributor; and
a first transmission unit that transmits the motion information to the server device,
the server device includes:
a first generation unit that generates a plurality of derived part images in which a character is drawn at mutually different angles or postures on a basis of an input image including the character;
a registration step of registering the derived part image as a distribution image for causing the character to move, and managing the plurality of derived part images in association with a parameter used for generating the plurality of derived part images; and
a second transmission unit that transmits motion information received from the distributor terminal and the derived part image generated by the first generation unit to the viewer terminal, and
the viewer terminal includes:
a second generation unit that generates an image of a character corresponding to a motion of the distributor on a basis of a derived part image and motion information received from the server device; and
a display control unit that causes a display unit to display an image generated by the second generation unit.

24. A control method of a device, the control method comprising:
a generation step in which a generation unit of the server device generates a plurality of derived part images in which a character is drawn at mutually different angles or postures on a basis of an input image including the character; and
a registration step in which a registration unit of the server device registers the derived part image as a distribution image for causing the character to move, and manages the plurality of derived part images in association with a parameter used for generating the plurality of derived part images.
